(19) United States
(12) Patent Application Publication
(10) Pub. No.: US 2002/0014844 A1
(43) Pub. Date: Feb. 7, 2002

(54) DOUBLE CAPACITOR

(76) Inventors: Steven Bardell, Essex (GB); Geoffrey Thomas Clayworth, Essex (GB)

Correspondence Address: VENABLE, P O Box 34385, Washington, DC, 20043-9998, US

(21) Appl. No.: 09/494,515

(22) Filed: Jan. 31, 2000

(30) Foreign Application Priority Data
Jan. 26, 1999 (GB) 9901616.4

(51) Int. Cl. H01J 29/98

(52) U.S. Cl. 315/1; 315/3.5

(57) ABSTRACT

In an electron beam tube arrangement, such as an IOT amplifier, an input cavity surrounds an electron gun. The cavity includes parts which are at high and low relative electrical potentials. These are separated by RF chokes to provide dc isolation whilst acting as a short circuit to high frequency radiation coupled into the cavity. The arrangement also includes a bypass capacitor located behind the electron gun which short circuits stray or leakage radiation to prevent deterioration of the amplified signal. The bypass capacitor presents a distributed capacitance of low inductance. In one embodiment, the RF choke and bypass capacitor include insulating material defined by a common member on which metallization layers are deposited.

### FIELD OF THE INVENTION

This invention relates to electron beam tubes and more particularly to tubes in which stray or leakage high frequency energy is reduced or eliminated.

### BACKGROUND TO THE INVENTION

In an inductive output tube (IOT), a high frequency signal to be amplified is applied to an input cavity surrounding the electron gun to modulate the density of the electron beam generated by the electron gun. The modulated electron beam is then passed via a drift tube to an output cavity from which an amplified high frequency signal is coupled. In tubes of this type, RF energy from the region around the electron gun may cause undesirable oscillations which can have a detrimental effect on the amplified signal.

### SUMMARY OF THE INVENTION

According to the invention, there is provided an electron beam tube comprising an electron gun; and capacitor means which provides an RF choke capacitor between parts of a high frequency input cavity at different electrical potentials and which also provides a distributed bypass capacitor for short circuiting stray or leakage RF energy in a region behind the electron gun.

The invention is particularly applicable to IOTs. The provision of a bypass capacitor to short circuit the energy in the region behind the electron gun reduces or eliminates the unwanted oscillations improving the performance of the device. The RF choke capacitor also included in the capacitor means permits parts of the input cavity to be kept at different electrical potentials whilst still constraining the applied high frequency energy within the cavity.

Preferably, the bypass capacitor of the capacitor means has a cylindrical geometry, giving a capacitor having an inherently low inductance and providing a continuous, distributed capacitance, making it particularly suitable for use as a bypass capacitor in high frequency electron beam tubes such as IOTs. The bypass capacitor may comprise a hollow cylinder of dielectric material with cylindrical metal plates on its interior and exterior surfaces. Other components of the electron beam tube, such as electrical leads or support structures, may be located in the volume surrounded by the bypass capacitor.

Preferably, the RF choke capacitor and the bypass capacitor of the capacitor means each have conductive plates separated by electrically insulating material wherein the electrically insulating material is provided by a member common to both of them. This gives a compact arrangement and a simplified design which mechanically may also be made robust to resist, for example, shocks and vibration occuring during shipping and use. However, in another arrangement, the RF capacitor and the bypass capacitor may have no components in common.

In one embodiment of the invention, the common member providing the insulating material is wholly of one type of material. However, it could in other embodiments include different materials to provide different dielectric constants to tailor the characteristics of the RF choke capacitor and the bypass capacitor. The common member may be mechanically a single component formed from a single part, or from two or more separate parts joined together.

In one advantageous embodiment, the common member is a cylinder extensive from the parts of the input cavity at different electrical potentials into the region behind the electron gun. The cylinder may be uniform or may in an advantageous embodiment include a thinner wall in the region behind the electron gun to increase the capacitance of the bypass capacitor.

In one embodiment, at least one of the plates of the RF choke capacitor is also a plate of the bypass capacitor. For example, both capacitors may be defined by common plates consisting of metallisation, for example, extensive from the input cavity parts to a region behind the electron gun. In order to function correctly as the RF choke capacitor, the electrical length of the plates is an odd integral multiple of a quarter of the wavelength at the mid-band frequency of the tube, for example, λ/4, 3λ/4, 5λ/4 and so on. To provide maximum capacitance for the bypass capacitor, it is desirable that this is as long as practical for a particular tube. Thus, for this aspect of the invention, in addition to the length being maximized, it must also be carefully chosen to be the correct length so as to act as an RF choke. Where the plates of the RF choke capacitor and the bypass capacitor are separate, then the RF choke capacitor again is an odd integral number of quarter wavelengths long but there is no constraint on the length of the bypass capacitor. In one preferred embodiment the capacitors are defined by common plates and are at least 5λ/4 long.

In one embodiment a plate of the RF choke capacitor and a plate of the bypass capacitor are separated from one another by a gap. These may advantageously be electrically connected by a conductor extending across the gap. This may, for example, be implemented by several conductive tracks located equidistantly around the circumference of an insulating cylinder to minimize inductance. In another arrangement, a plate of the RF choke capacitor and a plate of the bypass capacitor are both electrically connected to a structure which is connected to the cathode of the electron gun. The bypass capacitor may in one embodiment be electrically connected to part of the input cavity. Typically, the input cavity is maintained at ground or near ground potential whereas the cathode is at a relatively high potential, some tens of kilovolts being typical.

According to a feature of the invention, a beam tube arrangement includes an electron beam tube in accordance with the invention and input and output cavity circuits connected thereto.

### BRIEF DESCRIPTION OF DRAWINGS

Some ways in which the invention may be performed are now described by way of example with reference to the accompanying drawings in which:

FIG. 1 is a schematic diagram of an IOT amplifier in accordance with the invention;

FIG. 2 schematically shows part of the IOT amplifier of FIG. 1 in greater detail;

FIG. 3 schematically shows another embodiment of the invention in which the RF choke and bypass capacitors have common plates; and

FIGS. 4 and 5 illustrate schematically other arrangements in accordance with the invention.

### DESCRIPTION OF PREFERRED EMBODIMENTS

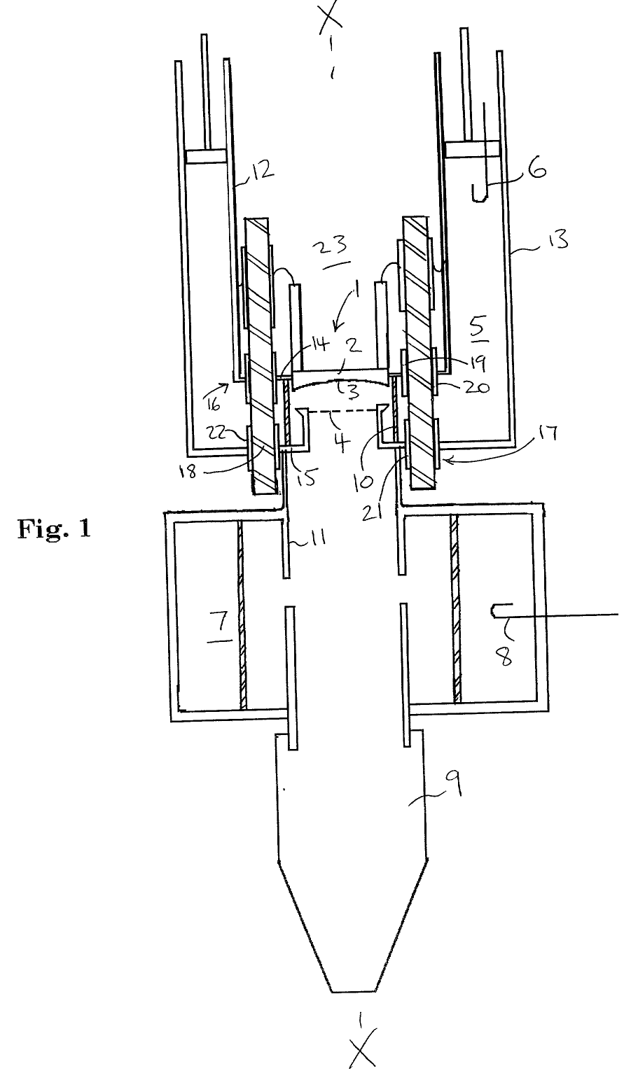

With reference to FIG. 1, an IOT amplifier includes an electron beam tube with an electron gun 1 having a cathode 2 with a concave front surface 3 from which, in use, electrons are emitted. A grid 4 is located in front of the cathode 2.

A high frequency resonant input cavity 5 is of annular cross-section and is arranged coaxially about the electron gun 1 around the longitudinal axis X-X of the arrangement. A high frequency signal to be amplified is applied to the input cavity 5 via a coupling loop 6. This causes modulation of the electron beam in the cathode/grid space. The modulated electron beam is transmitted along the axis X-X to an output cavity 7 from which an amplified RF signal is extracted via a coupling loop 8. The spent electrons of the beam are then intercepted at a collector 9.

The region in which the electron beams are generated and transmitted is surrounded by a vacuum envelope which, in this schematic diagram, is partially defined by ceramic support and RF window 10, drift tube 11 and collector 9. Those portions of the input and output cavities 5 and 7 outside the vacuum envelope, often termed “the cavity circuits”, may be removed from the tube for transportation or servicing, for example.

The input cavity 5 has an outer part including cylindrical walls 12 and 13 which are maintained at or near ground potential during use. The cathode 2 is maintained at approximately 35 kV. Part of the input cavity 5 is defined by a wall 14 which is electrically connected to the cathode 2 and a wall 15 which is electrically connected to the grid 4 and is also maintained at a very high potential. The parts 14 and 15 of the input cavity 5 at high potential and those 12 and 13 at ground are electrically isolated from one another by RF chokes shown generally at 16 and 17. In this arrangement, the RF chokes 16 and 17 each incorporate a common ceramic cylinder 18 extensive across the input cavity 5, but in other arrangements, each RF choke may have an insulating layer which is separate from that of the other. The RF choke 16 includes layers of metallisation 19 and 20 on its inner and outer surfaces which define the plates of the capacitor. Similarly, the second choke 17 includes layers of metallisation 21 and 22 on its inner and outer surfaces. These chokes act to provide dc isolation between the parts of the input cavity at different electrical potentials whilst retaining the applied high frequency energy within the input cavity 5.

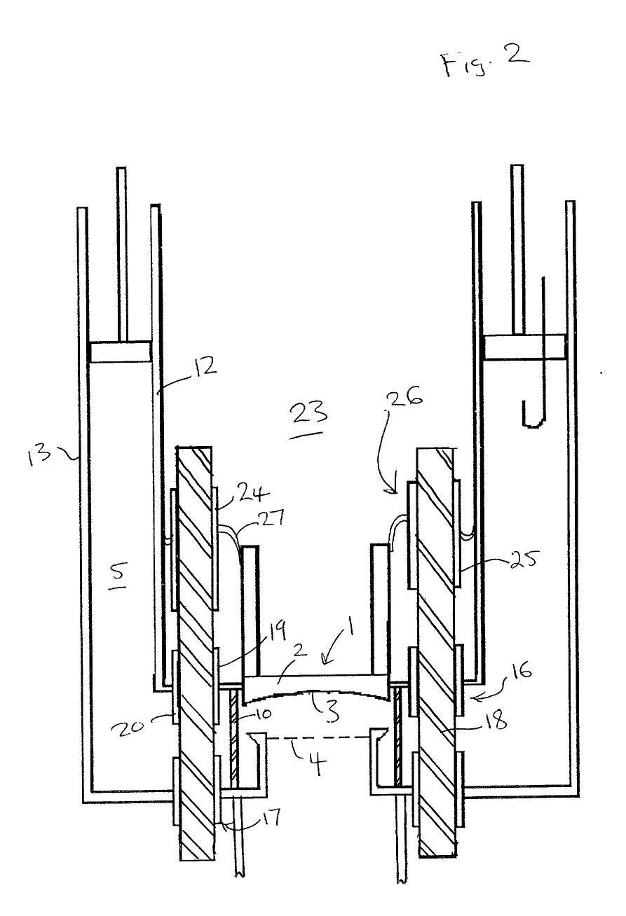

With reference to FIG. 2, the ceramic tube 18 which provides the insulating material for the RF choke 16 is extensive into the region indicated generally at 23 behind the electron gun 1, that is behind the front face 3 at which electrons are emitted. The inner surface of the insulator 18 carries a further layer of metallisation 24 and its outer surface a layer of metallisation 25, these layers forming the plates of a bypass capacitor 26. The plates 24 and 25 are separate from the layers of metallisation 19 and 20 included in the RF choke capacitor 16. The inner layer of metallisation 24 is connected via a plurality of spring fingers 27 to a structure which is mechanically and electrically connected to the cathode 2. Similarly, the metallisation 25 defining the outer plate of the bypass capacitor 26 is connected via a plurality of spring fingers to the inside wall 12 of the input cavity 5.

The RF choke 16 has metallisation layers which have an electrical length in the axial direction X-X of λ/4 at the mid-band frequency to ensure that it presents a short circuit to high frequency energy within the cavity 5. The axial extent of the metallisation 24 and 25 of bypass capacitor 26 is as long as can be conveniently accommodated. In one example, where the insulating material 18 is ceramic having a dielectric constant of 9 approximately and at a centre frequency of 714 MHz, a quarter wavelength is 3.5 centimetres. The RF choke metallisation is thus 3.5. centimetres long or an odd integral multiple of this length.

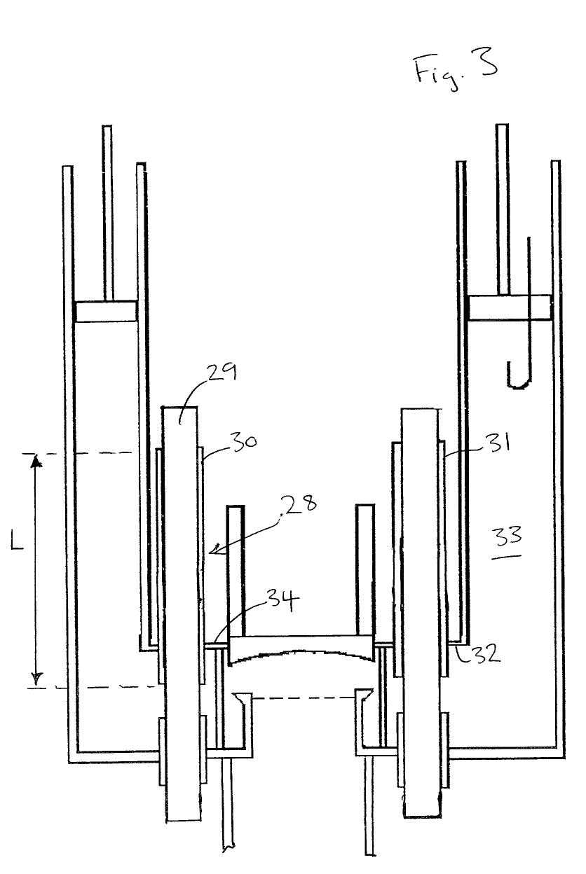

With reference to FIG. 3, an IOT amplifier similar to that shown in FIG. 1 includes capacitor means 28 comprising an elongate ceramic cylindrical tube 29 coated with metallisation layers 30 and 31 on its inner and outer surfaces respectively. In other arrangements one or both of the metallisation layers may be replaced by a metal member mounted on the ceramic tube 29. The outer layer of metallisation 31 is joined to a plate 32 which forms part of the wall of the surrounding annular input cavity 33 and in use is maintained at near ground potential. The inner layer of metallisation 30 is connected via wall 34 to parts of the IOT amplifier at cathode potential. The axial length of the metallisation shown at L is chosen such that its electrical length is an odd integral number of quarter wavelengths long. The structure thus acts as an rf choke capacitor to reduce leakage from within the cavity 33 whilst providing dc isolation between the parts at different potentials. The length of the metallisation extending into the region behind the cathode also ensures that it acts a bypass capacitor to absorb any stray or leakage radiation which might otherwise cause undesirable effects on the amplified signal. In this embodiment, the length L is at lens 5λ/4.

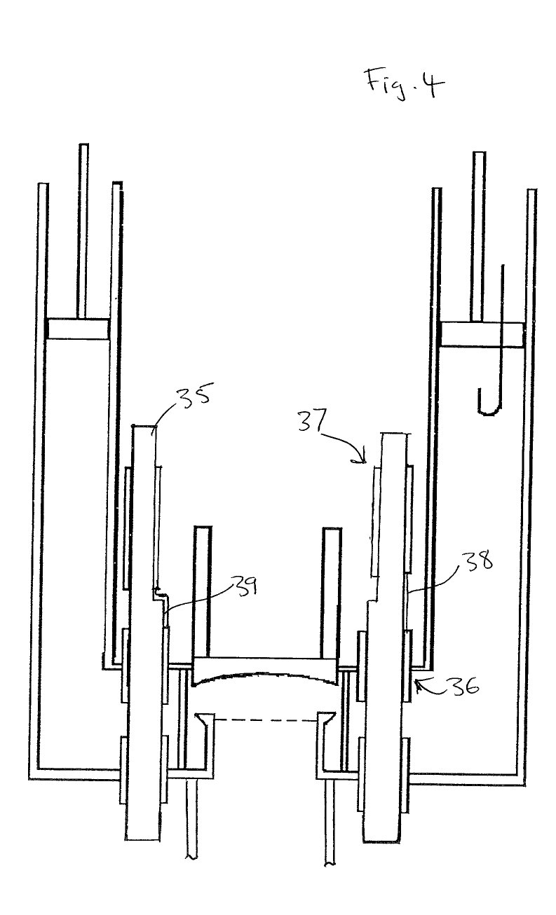

With reference to FIG. 4, again this shows part of an IOT amplifier in accordance with the invention. In this arrangement, a common ceramic member 35 provides electrical insulation material between the plates of the RF choke capacitor 36 and bypass capacitor 37 respectively. In this arrangement the ceramic member 35 has a cylindrical wall which is thinner at the bypass inductor than at the RF choke capacitor 36 to give increased capacitance. There is a gap between the plates of the capacitors 36 and 37. Four conductive tracks, two of which 38 and 39 are shown, are connected across the gap between the plates.

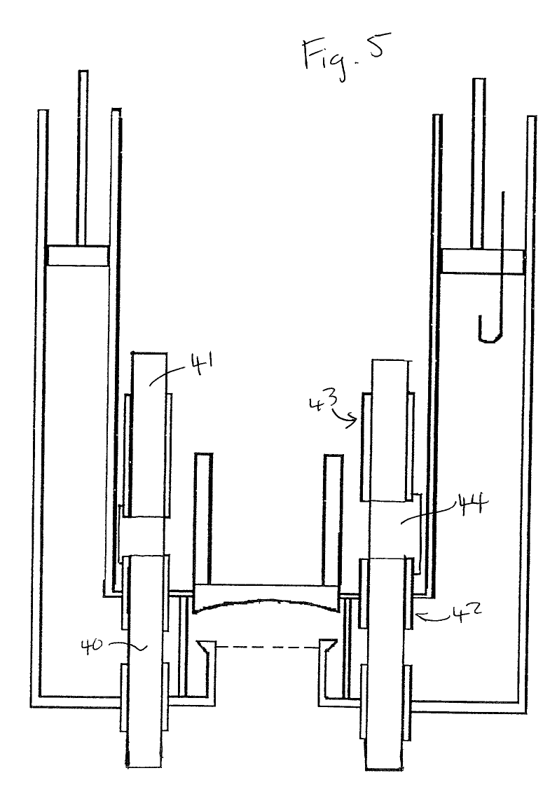

In each of the above embodiments, the insulating material is shown as a single unitary member. In other embodiments, the insulating material may be made of sections which are assembled together to form the mechanical common component. The insulating material may also include materials having different dielectric constants. FIG. 5 shows another arrangement in which two separate ceramic tubes 40 and 41 form the insulating material for the RF choke 42 and bypass capacitor 43 respectively. These two components are fixed against a third joining member 44 between them which also covers part of the metallisation to reduce risks of arcing.

We claim:

1. An electron beam tube comprising: an electron gun; and capacitor means which provides an RF choke capacitor between parts of a high frequency resonant input cavity at different electrical potentials and which provides a distributed bypass capacitor for short circuiting stray or leakage RF energy in a region behind said electron gun.

2. A tube as claimed in claim 1 wherein said bypass capacitor has a cylindrical geometry.

3. A tube as claimed in claim 1 wherein said RF choke capacitor and said bypass capacitor of the capacitor means each have a pair of conductive plates separated by electrically insulating material between said pair and wherein said electrically insulating material is provided by a member common to both the RF choke capacitor and the bypass capacitor.

4. A tube as claimed in claim 3 wherein said common member is wholly of one type of material.

5. A tube as claimed in claim wherein said common member is a cylinder.

6. A tube as claimed in claim 5 wherein said wall of the cylinder is thicker at said RF choke capacitor than at said bypass capacitor.

7. A tube as claimed in claim 3 wherein at least one of the plates of said RF choke capacitor is also a plate of said bypass capacitor.

8. A tube as claimed in claim 7 wherein said at least one plate has a length of at least 5λ/4.

9. A tube as claimed in claim 3 wherein at least one plate of said RF choke capacitor is separated from at least one plate of said bypass capacitor by a gap.

10. A tube as claimed in claim 9 wherein the said at least one plates separated by the gap are electrically connected to one another by an electrical conductor extending across the gap.

11. A tube as claimed in claim 9 wherein the said at least one plates separated by the gap are both electrically connected to a structure electrically connected to the cathode of said electron gun.

12. A tube as claimed in claim 1 and wherein a plate of said bypass capacitor is electrically connectable to part of said input cavity at relatively low potential.

13. A tube as claimed in claim 1 wherein at least one of the plates of said capacitor means is defined by a layer of metallisation.

14. A tube as claimed in claim 1 wherein said capacitor means is located outside a vacuum envelope around the cathode of said electron gun.

15. A tube as claimed in claim 1, wherein said tube is an IOT.

16. An electron beam tube arrangement including: an input cavity; and output cavity; and a tube comprising: an electron gun; and capacitor means which provides an RF choke capacitor between parts of a high frequency resonant input cavity at different electrical potentials and which provides a distributed bypass capacitor for short circuiting stray or leakage RF energy in a region behind said electron gun.

17. An arrangement as claimed in claim 16 wherein the beam tube arrangement is an IOT amplifier.
